(19) United States
(12) Patent Application Publication
(10) Pub. No.: US 2010/0269869 A1
(43) Pub. Date: Oct. 28, 2010

(54) SIMPLE OZONE VEGETABLE AND FRUIT WASHING MACHINE

(76) Inventor: Kuei-Tang CHANG, Banchiau City (TW)

Correspondence Address: HDLS Patent & Trademark Services, P.O. BOX 220746, CHANTILLY, VA, 20153-0746, US

(21) Appl. No.: 12/430,270

(22) Filed: Apr. 27, 2009

(51) Int. Cl. A23N 12/02; B08B 3/02

(52) U.S. Cl. 134/58 R; 134/99.1

(57) ABSTRACT

An ozone vegetable and fruit washing machine utilizes ozone water to wash the vegetables and fruits. A tub is provided in a casing. A water pump and an ozone generator module are sandwiched between the casing and the tub. The water pump is connected with nozzles toward the interior of the tub. The water in the tub is delivered to the nozzles and ejected by the nozzles. The ozone generated by the ozone generator module is delivered to the bottom inside the tub, and the ozone is solved in water to form ozone water. In addition, a washing vessel is further provided in the tub for accommodating the vegetables and fruits to be washed. The ozone water is pumped by the water pump for circulation use, and the ozone water is ejected by the nozzles, whereby the rolling vegetable and fruits driven by eddies can be washed completely.

### BACKGROUND OF THE INVENTION

1. Field of the Invention

The present invention relates to a vegetable and fruit washing machine, and in particular to a device for washing vegetables and fruits by using ozone water.

2. Description of Prior Art

Before eating vegetables and fruits, the impurities and poisons attached on the surface of fruits or deposited between vegetables are often washed out by clean water. With the development of science and technology, many studies have pointed out that ozone can be solved in the water to produce ozone water for washing vegetables and fruits, and the ozone water can eliminate bacteria and poisons remaining on the surface of the vegetables and fruits due to the strong oxidability of ozone.

Taiwan Patent No. M257768 discloses a device for washing vegetables and fruits by ozone, in which a hollow casing is provided. The bottom of the casing is provided with a motor, an ozone generator, pipes, valves and other elements. A washing basket driven by the motor is provided in the casing. Vegetables and fruits are put in the washing basket and then clean water is filled therein. The ozone generated by the ozone generator is solved in the clean water. Subsequently, the motor drives the washing basket to rotate, thereby washing vegetables and fruits by the ozone water.

However, in the above-mentioned device, it is necessary to provide a transmission means to cause the rotation of the washing basket, which makes the whole structure more complicated. Further, as disclosed in Taiwan Patent No. M344852, a washing tub is provided on a base. The washing tub is provided therein with a central water-ejecting post. The central water-ejecting post ejects the ozone water, thereby washing the fruits in the washing tub. However, the central water-ejecting post in the washing tub will hinder the arrangement of vegetables and fruits. As a result, the vegetables and fruits may not roll easily when being washed, which deteriorates the cleaning effect and thus does not conform to the requirements for cleanness.

Therefore, in order to overcome the above problems, the present Inventor proposes a reasonable and novel structure based on his delicate researches and expert experiments.

### SUMMARY OF THE INVENTION

The present invention is to provide a simple ozone vegetable and fruit washing machine, in which a water pump and nozzles are provided. Ozone water is pumped by the water pump and delivered to the nozzles, and then the nozzles eject the ozone water, thereby forming eddies to facilitate the rolling of vegetables and fruits in a washing vessel. Thus, the vegetables and fruits can be washed completely. Via the above arrangement, the whole structure of the simple ozone vegetable and fruit washing machine can be simplified so as to reduce the cost.

The present invention is to provide a simple ozone vegetable and fruit washing machine, in which the water pump pumps the ozone water for circulation, thereby saving water and thus conforming to the requirements for environmental protection.

The present invention is to provide a simple ozone vegetable and fruit washing machine, which includes a tub, a water pump, an ozone generator module and a washing vessel. One side wall of the tub is provided with at least one insertion hole. The bottom of the tub is provided with a through-hole and a water-drawing hole. The water pump is provided outside the tub. Both ends of the water pump are provided with a water-entering pipe and a water-exhausting pipe respectively. The water-entering pipe is inserted into the water-drawing hole. The water pump is further provided with at least one nozzle that is connected to the water-exhausting pipe and inserted into the insertion hole. The ozone generator module has an ozone pipe and is provided outside the tub. The ozone pipe is inserted into the through-hole. The washing vessel is disposed in the tub.

The present invention is to provide a simple ozone vegetable and fruit washing machine, which includes a casing, a tub, a water pump, an ozone generator module and a washing vessel. The tub is accommodated in the casing. The water pump and the ozone generator module are sandwiched between the casing and the tub. The water pump is connected with a nozzle that faces toward the interior of the tub. The ozone generator module has an ozone pipe. The ozone pipe is inserted into the bottom of the tub and is in communication with the interior of the tub. The washing vessel is accommodated in the tub.

In comparison with prior art, the simple ozone vegetable and fruit washing machine according to the present invention is provided with a water pump for pumping ozone water. Then, the ozone water is ejected via the nozzle to generate eddies for causing the rolling of the vegetables and fruits. In this way, the vegetables and fruits can be washed completely. Instead of a complicated transmission means for driving the rotation of a washing basket in prior art, the structure of the present invention is simplified so as to reduce the cost. Further, according to the present invention, the ozone water is pumped by the water pump for circulation, thereby saving the water and conforming to the requirements for environmental protection.

### BRIEF DESCRIPTION OF THE DRAWINGS

FIG. 1 is an exploded perspective view of the present invention;

FIG. 2 is an assembled perspective view showing the tub of the present invention;

FIG. 3 is an assembled perspective view showing another side of the tub of the present invention;

FIG. 4 is an assembled cross-sectional view of the present invention; and

FIG. 5 is a schematic view showing the operating state of the present invention.

### DETAILED DESCRIPTION OF THE INVENTION

In order to make the Examiner to better understand the characteristics and technical contents of the present invention, a detailed description relating thereto will be explained with reference to the accompanying drawings. However, the drawings are illustrative only but not used to limit the present invention.

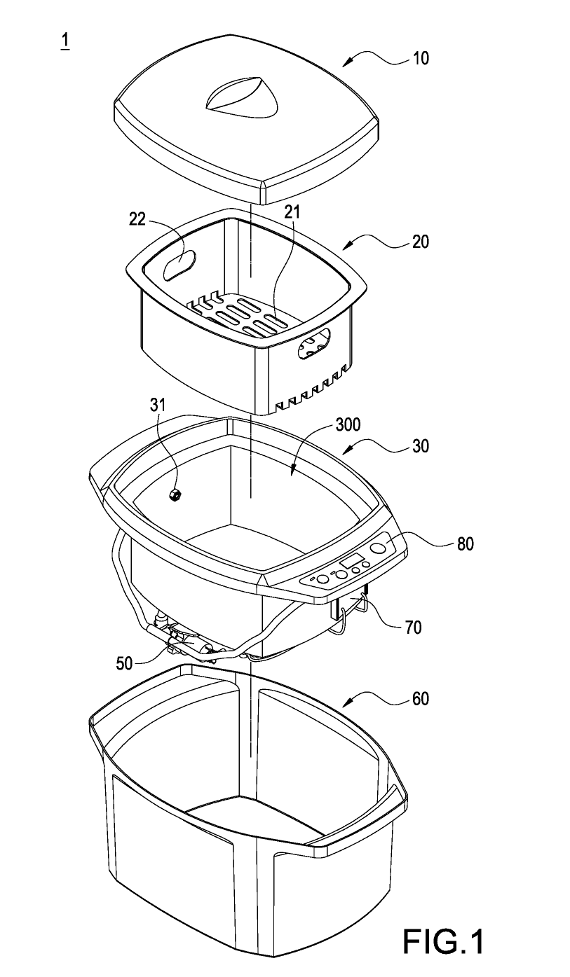

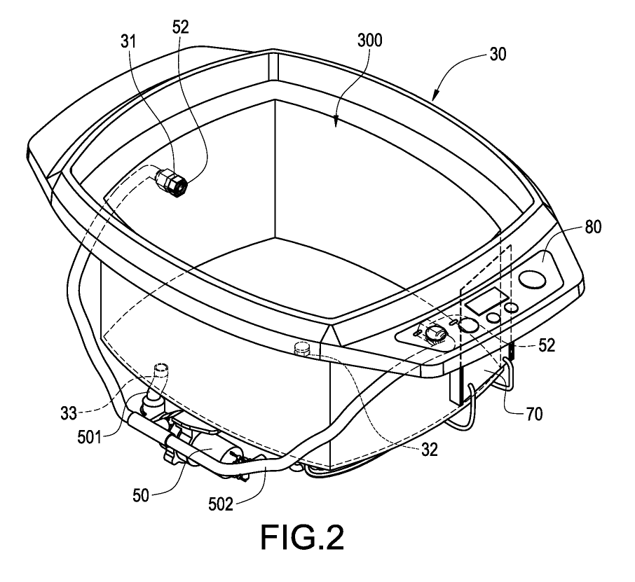

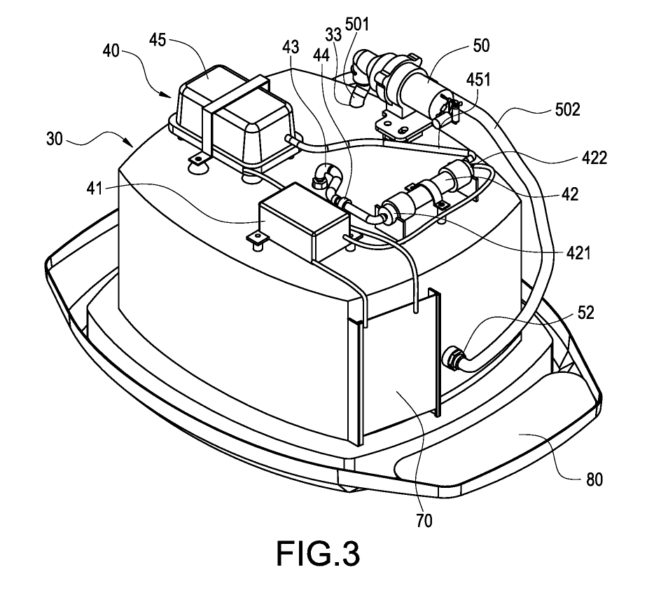

Please refer to FIGS. 1 to 3. The present invention provides a simple ozone vegetable and fruit washing machine, which includes a cover 10, a washing vessel 20, a tub 30, an ozone generator module 40 and a water pump 50 and a casing 60.

The cover 10 covers the washing vessel 20 and the tub 30. The washing vessel 20 is used to support the vegetables and fruits to be washed. The bottom and both sides of the washing vessel 20 are provided with slots 21, 22. The user can hold the slots 22 on both sides of the washing vessel. After the vegetables and fruits are washed completely, the washing vessel 20 can be removed from the tub 30, so that excessive water can be drained out from the slots 21 on the bottom of the washing vessel.

The tub 30 is accommodated in the casing 60. The washing vessel 20 is accommodated in the interior 300 of the tub. The side wall of the tub 30 is provided with at least one insertion hole 31. The bottom of the tub 30 is provided with a through-hole 32 and a water-drawing hole 33. The outside of the tub 30 is provided with the ozone generator module 40 and the water pump 50. The outside of the tub 30 is fixed with a circuit board 70. The circuit board 70 is electrically connected to the ozone generator module 40 and the water pump 50 for controlling their operation. Further, the circuit board 70 is electrically connected to a control panel 80 that is provided above one side of the tub 30. The control panel 80 is provided with a plurality of control buttons. By pressing the control buttons, the operation of the ozone vegetable and fruit washing machine 1 can be controlled.

The ozone generator module 40 is provided outside the tub 30, which includes an ozone generator 41 and an ozone-generating pipe 42. By means of a high-pressure action, the ozone generator 41 and the ozone-generating pipe 42 can generate ozone. The ozone-generating pipe 42 is electrically connected to the ozone generator 41 and has a gas outlet 421 and a gas inlet 422. The gas outlet 421 is connected to an ozone pipe 43. The ozone pipe 43 is inserted into the through-hole 32 on the bottom of the tub 30 and is in communication with the interior 300 of the tub. The ozone pipe 43 is provided with a one-way valve 44 for preventing the gas from flowing reversely. Thus, the ozone generated by the ozone generator module 40 can be delivered from the ozone pipe 43 and solved in the water filled in the interior 300 of the tub, thereby forming ozone water. In addition, the gas inlet 422 is connected to a gas pump 45 that is provided outside the tub 30 with a rubber pipe 451. The rubber pipe 451 is connected with the gas inlet 422 of the ozone-generating pipe 42 for delivering the gas into the ozone-generating pipe 42.

The water pump is also provided outside the tub 30. Both ends of the water pump 50 are provided with a water-entering pipe 501 and a water-exhausting pipe 502. The water-entering pipe 501 is inserted into the water-drawing hole 33 of the tub 30. The water pump 50 is further connected to at least one nozzle 52. The nozzle 52 is connected to the water-exhausting pipe 502 and inserted into the insertion hole 31 of the tub 30 toward the interior 300 of the tub. Thus, the ozone water in the tub 30 enters the water-entering pipe 501 via the water-drawing hole 33, and the ozone water is pumped by the water pump 50 to be delivered to the nozzle 52 and the interior 300 of the tub. In this way, the ozone water can be used for circulation. In the present embodiment, the tub 30 is provided with two nozzles 52. In practice, the water pump 50 is provided with a multi-port pipe. With the water pump 50 and the multi-port pipe, the ozone water can be delivered to a plurality of nozzles 52. Further, the nozzles 52 can be distributed uniformly in the tub 30, thereby generating more eddies to facilitate the rolling of vegetables and fruits. In this way, the vegetables and fruits can be washed completely.

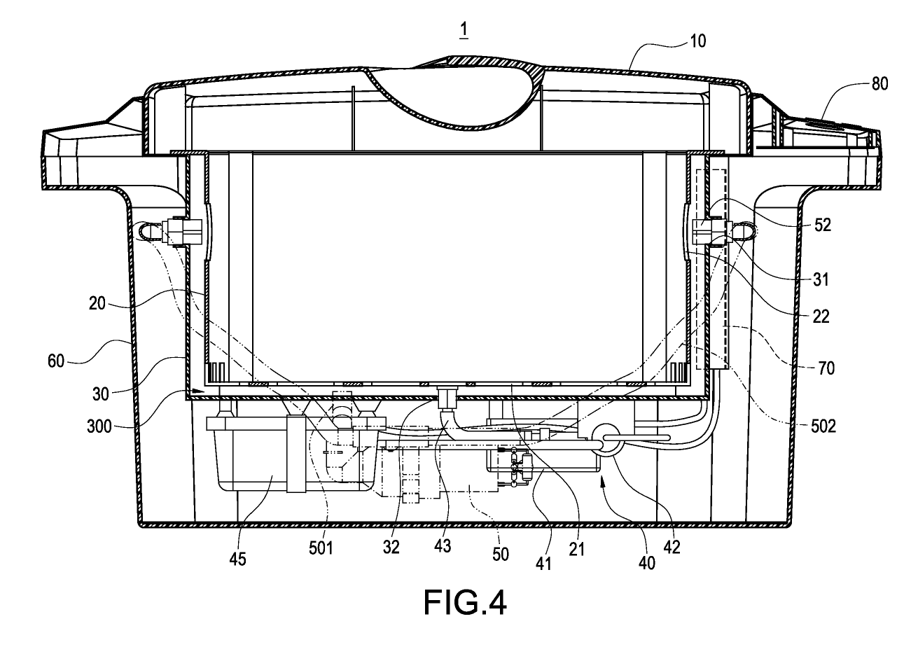

Please refer to FIG. 4, which is an assembled cross-sectional view showing the simple ozone vegetable and fruit washing machine of the present invention. As shown in this figure, the ozone generator module 40 and the water pump 50 are sandwiched between the casing 60 and the tub 30. The two nozzles 30 extend from the water pump 50 and are disposed in the insertion hole 31 of the tub 30. When the washing vessel 20 is disposed in the tub 30, the positions of the slots 22 of the washing vessel 20 correspond to the positions of the nozzles 52, so that the nozzles 52 can eject the ozone water toward the interior of the washing vessel 20.

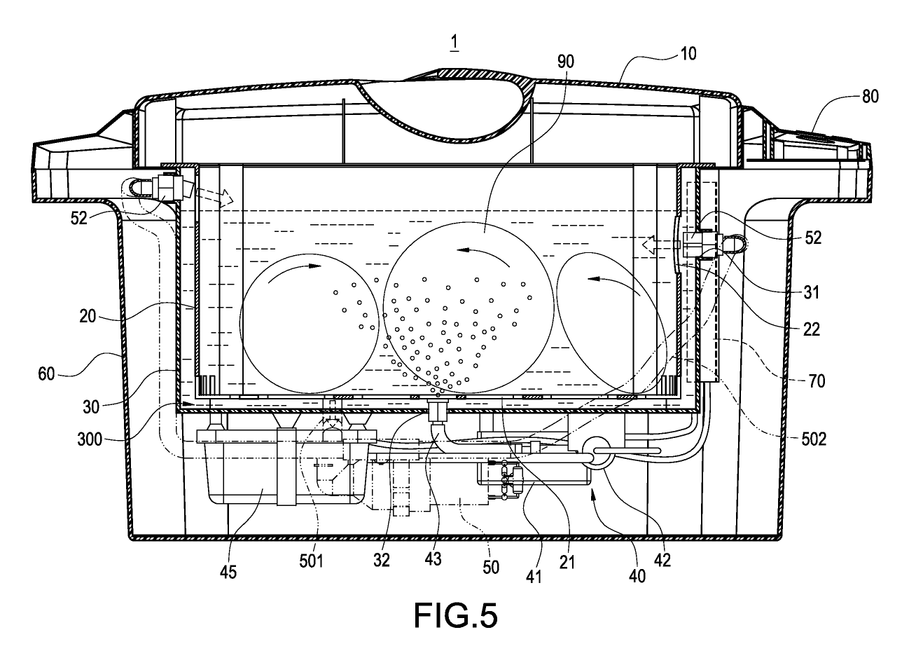

Please refer to FIG. 5, which is a schematic view showing the operating state of the simple ozone vegetable and fruit washing machine according to the present invention. In use, water is injected into the tub 30 until occupying 70 to 80% of the volume of the tub. Then, the ozone generator module 40 is activated to generate ozone. The ozone is delivered from the ozone pipe 43 and solved in the water to form ozone water. Subsequently, the vegetables and fruits are disposed in the washing vessel 20. The ozone water is pumped by the water pump 50 to enter the water-entering pipe 501. Then, the ozone water is delivered to the two nozzles 52 via the water-exhausting pipe 502. The two nozzles are provided on both sides of the tub 30 with different levels, thereby generating more eddies to facilitate the rolling of the vegetables and fruits 90. In this way, the vegetables and fruits 90 can be washed more completely.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A simple ozone vegetable and fruit washing machine, comprising:
a casing;
a tub accommodated in the casing, one side wall of the tub being provided with at least one insertion hole, the bottom of the tub being provided with a through-hole and a water-drawing hole;
a water pump provided between the tub and the casing, both ends of the water pump being provided with a water-entering pipe and a water-exhausting pipe, the water-entering pipe being inserted into the water-drawing hole, the water pump being further provided with at least one nozzle, the nozzle being connected to the water-exhausting pipe and inserted into the insertion hole;
an ozone generator module provided between the tub and the casing, the ozone generator module having an ozone pipe, the ozone pipe being inserted into the through-hole; and
a washing vessel accommodated in the tub.

2. The simple ozone vegetable and fruit washing machine according to claim 1, further comprising a cover covering above the tub.

3. The simple ozone vegetable and fruit washing machine according to claim 1, wherein the ozone generator module comprises an ozone generator and an ozone-generating pipe, the ozone-generating pipe is electrically connected to the ozone generator and has a gas outlet, and the gas outlet is connected to the ozone pipe.

4. The simple ozone vegetable and fruit washing machine according to claim 3, wherein the ozone generator has a gas inlet, the ozone generator module further comprises a gas pump, the gas pump is provided outside the tub with a rubber pipe, and the rubber pipe is connected with the gas inlet.

5. The simple ozone vegetable and fruit washing machine according to claim 1, wherein the ozone pipe is provided with a one-way valve.

6. The simple ozone vegetable and fruit washing machine according to claim 1, further comprising a circuit board, the circuit board being fixed outside the tube and electrically connected to the ozone generator module and the water pump.

7. The simple ozone vegetable and fruit washing machine according to claim 6, further comprising a control panel having a plurality of control buttons, the control panel being electrically connected to the circuit board and fixed to one side of the tub.

8. The simple ozone vegetable and fruit washing machine according to claim 1, wherein the bottom and both sides of the washing vessel are provided with slots, and the positions of the slots on both sides of the washing vessel correspond to the positions of the nozzles.

9. A simple ozone vegetable and fruit washing machine, comprising:
a casing;
a tub accommodated in the casing;
a water pump provided between the tub and the casing, the water pump being connected with a nozzle toward the interior of the tub; and
an ozone generator module provided between the tub and the casing, the ozone generator module having an ozone pipe, the ozone pipe being inserted into the bottom of the tub and in communication with the interior of the tub.

10. The simple ozone vegetable and fruit washing machine according to claim 9, further comprising a washing vessel accommodated in the tub.

11. The simple ozone vegetable and fruit washing machine according to claim 9, wherein the bottom of the tub is provided with a water-drawing hole, one end of the water pump is connected to a water-entering pipe, and the water-entering pipe is connected to the nozzle and inserted into the water-drawing hole.

12. The simple ozone vegetable and fruit washing machine according to claim 11, wherein the side wall of the tub is provided with an insertion hole, the other end of the water pump is connected with a water-exhausting pipe, and the nozzle is connected to the water-exhausting pipe and inserted into the insertion hole toward the interior of the tube.

13. The simple ozone vegetable and fruit washing machine according to claim 9, wherein the bottom of the tub is provided with a through-hole, and the ozone pipe is inserted into the through-hole to be in communication with the interior of the tub.

14. The simple ozone vegetable and fruit washing machine according to claim 13, wherein the ozone pipe is provided with a one-way valve.

15. The simple ozone vegetable and fruit washing machine according to claim 9, wherein the ozone generator module comprises an ozone generator and an ozone-generating pipe, the ozone-generating pipe is electrically connected to the ozone generator and has a gas outlet, and the gas outlet is connected to the ozone pipe.

16. The simple ozone vegetable and fruit washing machine according to claim 15, wherein the ozone generator has a gas inlet, the ozone generator module further comprises a gas pump, the gas pump is provided outside the tub with a rubber pipe, and the rubber pipe is connected with the gas inlet.

17. The simple ozone vegetable and fruit washing machine according to claim 9, further comprising a circuit board, the circuit board being fixed outside the tube and electrically connected to the ozone generator module and the water pump.

18. The simple ozone vegetable and fruit washing machine according to claim 9, further comprising a control panel having a plurality of control buttons, the control panel being electrically connected to the circuit board and fixed to one side of the tub.

19. The simple ozone vegetable and fruit washing machine according to claim 9, wherein the bottom and both sides of the washing vessel are provided with slots, and the positions of the slots on both sides of the washing vessel correspond to the positions of the nozzles.
